(19) United States
(12) Patent Application Publication
(10) Pub. No.: US 2008/0184122 A1
(43) Pub. Date: Jul. 31, 2008

(54) System and method for conducting on-line discussions.

(76) Inventors: Michael A. Grant, Quaix en Chartreuse (FR); Jeffrey Mark Sieracki, Silver Spring, MD (US)

Correspondence Address: Jeffrey Sieracki, 13506 Collingwood Ter, Silver Spring, MD, 20904, US

(21) Appl. No.: 12/013,469

(22) Filed: Jan. 13, 2008

Related U.S. Application Data
(60) Provisional application No. 60/880,078, filed on Jan. 13, 2007.

(51) Int. Cl. G06F 3/00

(52) U.S. Cl. 715/723

(57) ABSTRACT

A system for conducting on-line discussion which facilitates said discussion by means of allowing contribution of asynchronous audio-visual segments from at least one class of users, standardizing these segments according to common parameters, linking these segments into smooth streams that are visible by at least one class of user as if they had been generated continuously in a discussion or debater format. The invention includes methods of collecting and standardizing said segments. Embodiments allow for threaded and linked viewer interaction, as well as moderator style control.

This patent application is based on a Provisional Patent Application Ser. No. 60/880,078, filed on 13 Jan. 2007.

### FIELD OF THE INVENTION

The current invention relates to discussion and forums in an on-line or web-based setting, and more particularly, to conducting debates or engaging in similar interactions where two or more parties wish to express or exchange opinions and ideas. The invention also relates to audio, video, image, and text processing and organization of information threaded by topic for easy access by multiple users. It further relates to automatic pre-processing, clean up, editing, and re-assembly of the subject information and to the distribution of subject information.

### BACKGROUND OF THE INVENTION

Debate and discussion, whether political, intellectual, business, social, or otherwise, benefits from organizational structure. For example, political debates are typically conducted in settings with a strict format organized in advance by negotiation. Likewise, parliamentary or boardroom discussions generally follow their own rules of order. This allows the parties to have their say in a controlled and equitable fashion.

Traditional in-person or televised debates are limited, however, by constraints such as collocation of the participants, restrictions on total time, and difficulties in allocating time and transitioning among subject matter. Phone and video conferencing helps alleviate the need for collocation, but often adds idiosyncratic difficulties in communicating smoothly and maintaining order. For example, slight time delays typical of video links both directly between stations and via the Internet add confusion. These “live” interaction systems also suffer from the requirement that all parties be simultaneously available, even when they are not co-located.

In order to facilitate live discussion between passionate parties while maintaining fairness, often moderators are employed. These individuals set the order of speaking, and the time allotted to each speaker; they also ask questions and set other limits that help move the discussion forward. They are forced to carefully balance total available time against full discussion of a particular issue, often leading to unsatisfactory compromise in which the participants are not able to fully develop and state their opinions or reactions.

The online web environment has enabled a newer form of discussion, known as “threading”. In threaded discussion, the participants discuss topics asynchronously and independently from one another. A participant may move from thread to thread adding a new opinion without concern that another thread is still in progress. A user can read a thread of interest without wading through subject matter that is not of interest. These discussions have been largely limited to textual exchange, with the occasional employment of attachments and links within the body to other modalities. Prior art has not addressed the unique challenges of conducting video discussion and debate in a threaded format.

Video interaction on the web has taken several forms, including live video conferencing; adaptations of standard media broadcasts in on-demand type formats; and loosely organized video upload sites. The media broadcasts push pre-produced material to users, but do not allow multi-party participation in the creation of the video. Video up-load services employ a basic scheme of user posting of pre-produced video files, however, videos require special skill to record, create, and edit, and the upload processes burdens the user with long, slow, failure-prone transfers. Organization of videos in these sites is haphazard at best, nor is their any mechanism to self-organize the component material into a smooth, orderly exchange and presentations. These sites cannot support the sort of targeted, interactive discussions that we propose.

### SUMMARY OF THE INVENTION

The present invention comprises means of collecting, posting, editing, organizing, and disseminating audio-visual information and associated textual and other data to facilitate online video discussion and debate.

The invention includes means for collecting video from participants in a user-friendly, controlled fashion that results in standard blocks that can be assembled later into coherent, linear presentations. It includes means for organizing and indexing these blocks, and for automatically assembling and streaming the video as needed to a distributed audience. In addition, it enables threaded video discussions where they were not previously easily achieved.

In some embodiments the invention also includes means for allowing viewers to provide feedback by rating the quality of the active participants' responses. In some embodiments, it also includes multi-tiered organization in which primary participants (such as political candidates) debate, while secondary participants (the traditional viewers) can join in the debate by expressing opinions in their own threads without necessarily interrupting or impinging on the primary debate thread.

The elements of the invention and its application in an online web setting enable user interaction in a way not previous feasible. The debaters can control their statements carefully and shift between topics at will without suffering the limitations of traditional settings. The audience members can control their viewing experience by selecting topics of interest, ignoring subjects of no interest, and providing feedback to the candidates. Of course the system includes means to conduct more “traditional” debates as well, simply using the web as a broadcast medium.

The invention also enables web based business revenue methods to be applied in a debate setting. Advertisements can appear in-stream in the video, as well as in clickable out-of-frame ads. Advertisements can be targeted to the user by matching debate topic key words and by monitoring user behavior. In addition, the system provides a novel means of self-organizing video, audio, and images of the participants that provides a library of content available for sale.

The on-line video debate environment, particularly threaded organization, automated editing, viewer feedback, and other elements individually or in combination with other features of the invention represent an advance over the state of the art.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a sample screen shot showing a list of discussion threads and the debaters involved in each discussion.

FIG. 2 is a sample screen shot showing viewer playback of a selected topic thread, together with other controls and information available to the user.

FIG. 3 is a pair of flow diagram showing the basic logic of recoding, reviewing, and adding videos to threads.

FIG. 4 is a flow diagram showing and automated editing process for enabling easy user video uploads.

FIG. 5 is a pair of flow diagrams showing the basic operational logic of different modes of playback available on the website.

FIG. 6 is a system block diagram illustrating the use of web distribution to serve large numbers of users with on-demand content.

### DETAILED DESCRIPTION OF PREFERRED EMBODIMENTS

The exemplary embodiments of the present invention will now be described in conjunction with the illustrations of the Drawings. The Drawings are intended to show the combination of features which form the invention when embodied as depicted. Additional programmatic details common to many systems or otherwise obvious to those skilled in the art are omitted. The primary embodiment described herein is directed toward a political debate website environment; however, it will be apparent that the same features of the present invention that facilitate organized political discussion can be equally well applied in other discussion settings. Therefore while the political web embodiment illustrates invention features, this example should not be interpreted as limiting the application of the invention to that specific field. Organized discussion of general topics, business meetings, etc., may likewise be improved or facilitated by the subject invention as will be apparent when the details are set forth below.

The goal of this example website embodiment is to allow visitors to see near real-time or simulated real-time debates between declared political candidates, while allowing the candidates and viewers to operate asynchronously. The medium is primarily video (with associated audio tracks) but audio and text exchanges are also included in certain embodiments. The “near live” aspect of the site means that visitors will see new video as it is posted to the site rather than direct from the debaters video camera. This feature allows us to give users a sense of presence and immediacy while maintaining the advantages of asynchronous updates from multiple locations and avoiding interaction delays and other difficulties inherent to fully live operation.

The example embodiment has 4 different accesses modes depending on the type of user:
1. The viewer's access which is simply what an ordinary viewer sees when they come to the site to watch the debates;
2. The debater's access which allows debaters to post their content and responses to the debate;
3. The moderator's/director's access which allows debates to be moderated; and,
4. The administrative access reserved for the people who run the site itself.

In other embodiments of the invention, the term “debater” may include any on-line discussion participant able to contribute primary content; “viewer” may include any user who is able to watch said content. We shall use terms such as “video” to describe the audio-visual segments recorded by debaters and viewed by viewers; however, it is contemplated that in some embodiments only audio or only visual segments may be recorded without the complimentary feature present. Moreover, other media formats such as “text” of HTML may be used in addition; therefore “video” or “audio-visual segment” terms used herein are for purposes of describing the example embodiment and not intended to limit embodiments of the invention which include other modes of postings content common in the art. We may refer to content segments in general as “postings” or “responses.”

In this example embodiment we consider participants in different tiers and assign different capabilities to each. For purposes of web-political discussion, the primary participants are the debaters that are declared candidates in a particular race. In certain embodiments users may be able to switch roles, acting in one instance as a viewer and in another as a debater.

In the example embodiment, initially, any declared candidate may start a debate. The debates may only be between candidates who are (a) declared or imminently declared and (b) who are within the same race (i.e. democratic presidential candidates running in the democratic primary). Alternatively, the debate site staff may call a debate, inviting specific participants.

In any case, all debate competitors are contacted and invited to the web site. They are notified of the debate by whatever means available to get them to join in the debate. In certain embodiments the invitation will happen automatically by email or other means established with the competitors staff. New competitors are given instructions on how to use the site, including a written summary and an online tour.

In addition to political debates between candidates, there will be a public part of the site where viewers can enter into debates with other viewers. It's within the scope of the invention that some of these public debates would have related content that is linked to the candidates' debates. This second tier of operation allows open participation rather than invitation-only participation. Public debaters may start their own threads from scratch, or may post a response to a candidate discussion thread. In the second case, the public debate thread is logically linked to the candidates debate thread and can be accessed by viewers at their option; however, the public thread is not integrated into the candidates' debate sequence and by default will be skipped by viewer-users who have not specifically asked to review it. In certain embodiments a small icon will appear to the viewer of a candidate debate thread video sequence indicating that a public response has been linked in at this point and is available for optional viewing. In other embodiments a tree-structure of the debate will be shown and the viewer will have the option of hiding or expanding the public debate sub-threads, and clicking on any point in the tree to access the corresponding video blocks. (See “Threads” below.) In certain embodiments, independent text discussion threads are permitted to be linked to any given video segment, while in others, text threads may be started separately.

In the example embodiments, it will also be possible to admit members of the public to the first-tier debate. This can be by pre-selection of the individuals by an authorized party such as (a) the moderator of (b) other first-tier debaters, permitting a “town-hall” type format. This can also be by election of the moderator to elevate a viewer-user second-tier video or text question into the first-tier candidates' thread for discussion; enabling public input to the first-tier debate in a controlled fashion. In certain embodiments it will also be possible for candidates to respond directly to viewer input of their own choice, by either elevating the user segment to the candidate discussion, or by simply adding a posting to a public thread.

The candidate debates in the preferred embodiment will be set to commence on a particular day/time allowing a reasonable amount of time after all the candidates have been notified. This will give fair and reasonable time for all candidates who are interested in joining the debate to log into their account on the debate site and become acquainted with the system if they are new. This is not necessary to the invention, and in other embodiments, debates or threads may be commenced on an ongoing basis.

The first-tier debaters will be given access to their personal debate control panel where they can watch the debate or post their responses in turn. These responses will be concatenated dynamically and automatically to create a smooth discussion of the issue at hand. While certain debates may be time limited, the invention permits discussion to be open ended in a way not previously possible in traditional media and the prior art.

Once a viewer initiates watching a discussion thread, the viewer will see a seamless debate unfold before them comprising a concatenation of all the video that is posted by the debaters on a topic. They can watch a single topic thread, or watch the combined debate as it unfolds in time. Other means of sorting and concatenation are also facilitated; for example, in certain embodiments a user may choose to watch only the postings of certain selected candidates of interest.

Similar to text forums on the Internet, debates in the preferred embodiment have “threads” organized by topic. In the preferred embodiment, a debater can pose a new question and start a new thread. This is exactly like starting a new debate except that all the threads of a particular debate are grouped together just like all threads in a forum are grouped by topic. In certain embodiments, threads will be subject to approval of or may only be initiated by the moderator; this makes the system behave in a more conventional debate fashion. The preferred embodiment offers the advantage of having candidates and (in certain embodiments) viewers drive the discussion topics, facilitating a debate style not possible in ordinary real-time settings. Because responses can be posted asynchronously candidates are able to consider the question before responding, or choose not to respond; threads may cover a broader array of topics that adapt to the interests of the debaters and audience without exhaustive vetting of questions in advance. In certain embodiments, to facilitate cooperative vetting of questions, new topic threads may be first presented to candidates (first-tier debaters) for a vote as to whether the topic will be made available to viewer-users in the standard thread; this “vote” may equivalently be taken by simply delaying the presentation of the new thread to viewers until a majority of first-tier debaters have responded with an initial posting.

Watching a debate, a viewer-user may select thread in a manner similar to watching a TV channel—when one thread program ends the next starts. Unlike traditional media, however, it is possible for users to filter out the threads they are not interested in, and skip around to watch other content or focus only on topics or candidates of interest. They are not restricted by fixed production formats.

Due to the continuous nature of the debate, significant content will accumulate over time in each thread. One would not want generally start from the beginning, rather users typically watch only from the last few days or last point of significant content being added to the thread or last hour or two of content. Certain embodiments will track the users last view and help the viewer resume where they left off without repeating material. The viewer can also rewind the thread back in time once it is playing, or skip forward.

In the preferred embodiment, there's nothing stopping a viewer from jumping from one thread to another or otherwise changing their selection of the material they wish to watch. In this case the system dynamically rebuilds a new viewing sequence customized to the user request. This is an advance in that the prior art typically requires users to watch preset sequences, or select individual videos for display one at a time.

In the preferred embodiments, the candidate initiating a thread or the moderator (if any) may end or close their thread when they are satisfied the question has been finished and it does not make any sense to leave the thread open; however, not generally before each participant has had a fair chance to respond. In certain embodiments, the candidates will take a vote to close a thread, with the topic only closing on majority approval. Typically the option to close a thread will only occur after each candidate has had an opportunity to speak at least once in a round of discussion; however, the preferred embodiment also includes a time limit after which it will be assumed an unresponsive candidate has nothing more to add.

Typically the candidates will have an opportunity to speak once in turn at each round. In certain embodiments the candidates will speak in a fixed sequence that is assigned at random, pre-negotiated, or assigned in order of their first postings to a thread. This has the advantage that the candidates know what they are responding to and need not worry about new posting from other candidates intervening before they finish their turn. In the example embodiment, the candidates are permitted to respond once per round in whatever order they enter their postings. Other embodiments allow free-form discussion in which debaters post as quickly and as frequently as they choose. Still others allow a human or machine moderator to decided to yield the “floor” to a particular candidate based on a request to speak; in this case request will be cued and the candidate will be given a fixed period to respond before he or she looses the chance and it passes to the next requester. The preferred embodiment includes software parameter settings that allow it to operate in any of these modes for a particular debate.

Public debates at the second-tier will typically be first-come, first-serve; however other methods may be employed circumstantially as discussed above.

Within a thread, responses are grouped together by time. For example, there may be a flurry of responses after a certain geo-political event, then no responses in a thread for a period of time. All the responses within the thread will be grouped together so that it is obvious to the viewer when the next group of responses are viewed that there is a gap of time. This feature of the preferred embodiment helps maintain the simulated real-time feel during viewing while making the temporal organization of the postings clear to the viewer.

Following multiple threads can become very complex and the number will typically be limited so as to not confuse the viewers or debaters. Starting a new thread is something that should not be done unless needed; hence, in certain embodiments this action is subject to restriction by a moderator. Multiple questions can be posed in a single thread over time; however organization will be enforced to improve user experiences. As discussed previously, viewer discussion threads are typically more freeform but can also be easily hidden and ignored by viewers to simplify browsing.

Posted segment content may contain questions can be aimed at one, more, or all of the other participants. In the event that a candidate fails to respond in a set period of time allotted for the discussion round, in the preferred embodiment open threads show an image indicating the candidate(s) who refused to respond to the question with and indicator icon flagging the situation. Typical icons include, an empty chair or a photo with question mark, a bandage, or hand over their mouth. Statistics of candidates not responding to questions will be tracked by the site so that viewers can see who the non-responsive candidates are.

In the example embodiment the debate between a set of registered candidates run continuously up until an election, with threads opening and closing as discussed. A viewer may view all the posts up to the current time. If they then re-visit the site at a later time, they would only be shown the video they have not already seen. In certain embodiments, a certain amount of video of the previous threads will be given to them to let them remember where they were and what the original question was; these highlights can be automatically generated, or hand edited by human reviews.

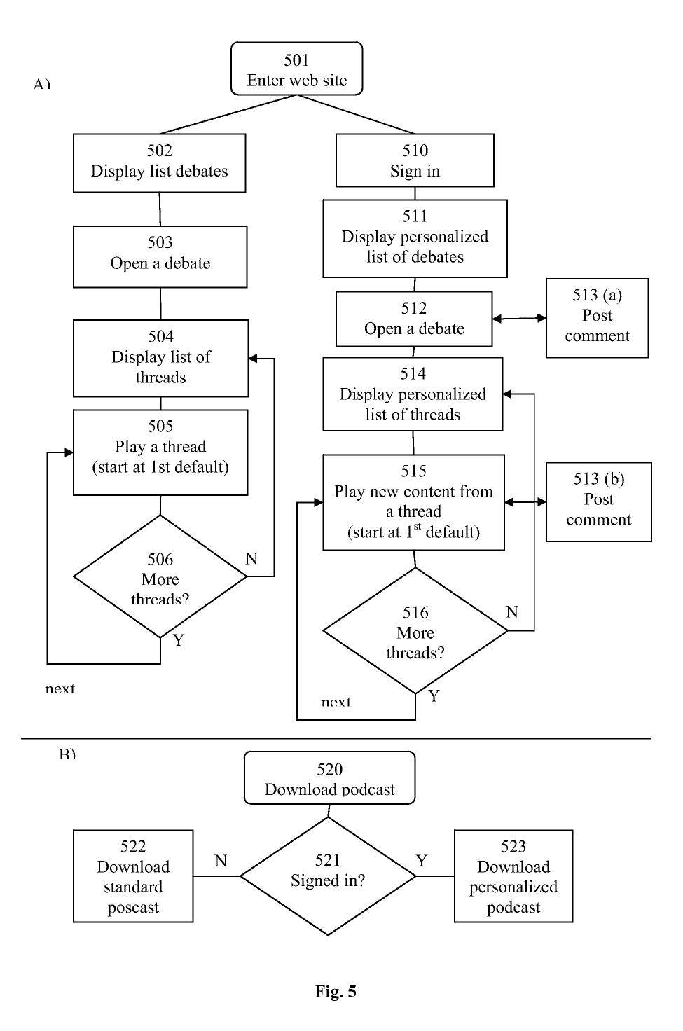

In certain embodiments, debates are available to be downloaded as podcasts or viewed directly on the website. A “podcast” refers to one or more files that are downloaded to a personal viewing/listening device for off-line playback. FIG. 5 illustrates high level flow charts; in particular 5b shows certain options for podcast viewing. Block 520 indicates initiation of downloading of podcasts. The system behaves differently depending upon whether they are signed in or not (block 521). If they are not signed in (block 523) a personalized podcast is downloaded; if they have not (block 522) a standard podcast is downloaded that will be similar to the default threads seen by a website user. When viewed as a podcast, the server will download only the video they have not already viewed or otherwise eliminated by personalized filters for the user. In the example embodiment, the user can select one of 3 ways to view the podcasts:
1. The new content is concatenated into one new podcast. For example, if there are 3 threads active and each of these 3 threads has 2 new video posts, the 6 video posts are concatenated into one podcast file. The user subscribing to this style of podcast would download one file each time they query the server for new content (usually once a day). Threads that were added to since the last time they looked would be played sequentially. i.e. first the 2 posts from the first thread, then the second 2 posts from the second thread and then the last 2 from the third.
2. Each thread is a separate podcast file. For example, if there are 3 threads and each thread has 2 new video posts, when the user queries the server for new content, they will receive 3 new podcasts. Maybe each thread is a separate subscription that they are automatically sent unless they filter it out by changing their subscription.
3. Raw. Each video post is a separate podcast file. In the above example with 3 threads and 2 posts in each thread, the user would receive 6 podcast files on this day.

In any case, the files are all “linked” together by being part of the same collection and by being numbered. Most personal playback devices will play them in sequence without a gap, as is well-known in the art. Options 2 and 3 should, because of the numbering sequence, automatically collate the video posts into the threads so the user can, on their playback device, stay within a thread rather than the playback jumping from thread to thread which could be confusing to follow. The preferred embodiment also allows download audio-only versions of the debates for lower bandwidth and smaller memory requirements.

Various modes of collecting revenue are enabled by the invention. While it is feasible to operate the website non-profit without compromising the features of the invention, the example embodiment includes means of generating revenue. These include contributions from the debaters, paid advertising that may be either inserted into the debates themselves or on the page along the side like, and payment for republication rights of collected audiovisual clips and still images.

This candidate fee helps eliminate candidates who are not serious candidates out of the debate and in the preferred embodiment will be set on a sliding scale high enough to prevent a barrier of entry but low enough to present a reasonable PR expense to serious candidates.

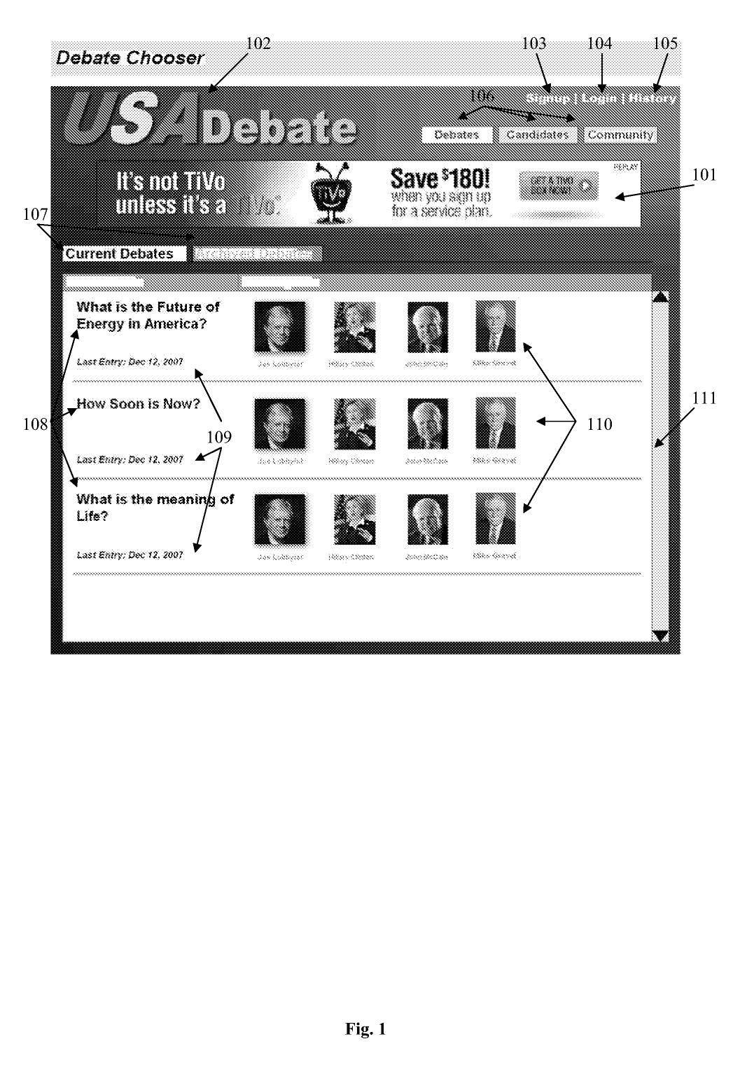

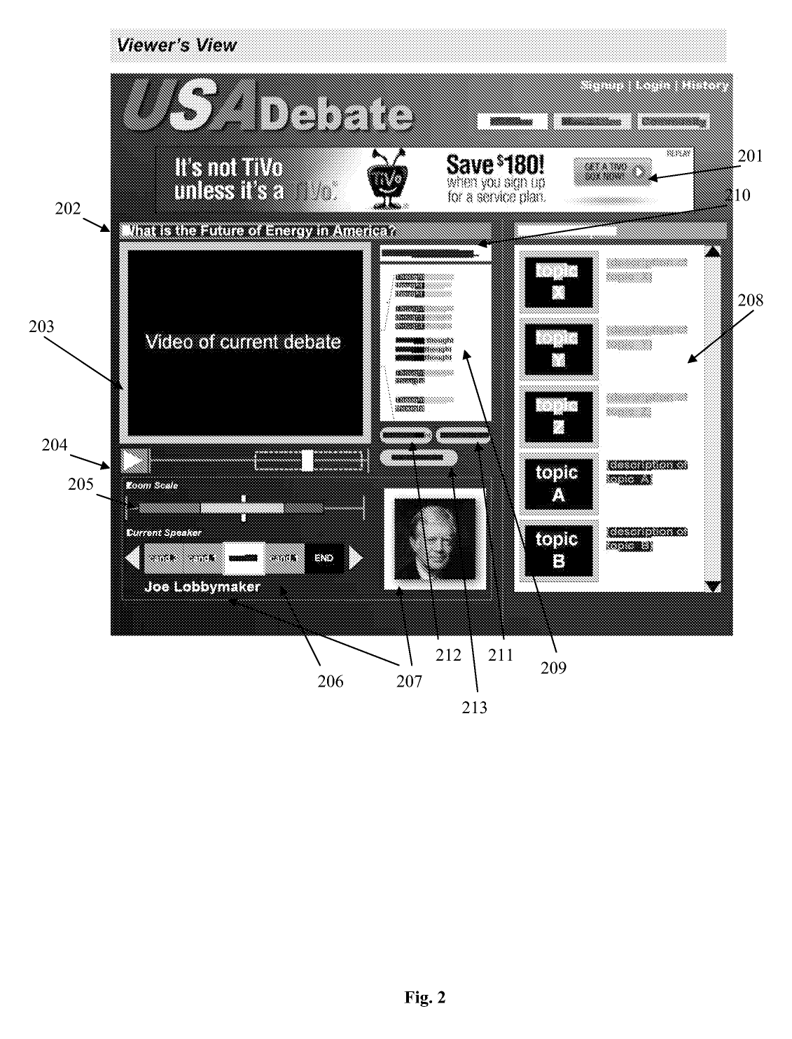

The paid advertisements operate on pay-per-click or pay-per-view systems; however other tracking fees can be implemented. Since the threads are keyed to subject matter certain embodiments will utilize key words to match ads to viewer selections and behavior. FIG. 1. and FIG. 2. both illustrate a top bar ads (101, 201). Video ads will be streamed into the video content box, shown in FIG. 2, 203. These two figures are further described below.

The system also presents a natural source of well-organized material that will be of interest to other media outlets. Video and audio clips of candidates and user responses, as well as still images will be automatically cataloged by topic, time, and other parameters for review and purchase by third parties.

We now explain the example viewer's view of the system. In the example embodiment, when the viewer goes to the main page of the site, they are presented with a list of the current running debates and the most popular older debates. There is also a means to see archived debates. Photos (if available) of the debaters associated with the debate they are involved in are used to ironically indicate participation.

FIG. 1 illustrates a sample screen shot showing a list of discussion threads and the debaters involved in each discussion. The page has a title 102 indicating the name of the website. The signup button 103 allows new users to sign up for personalized access. The login button 104 allows existing users to log for personalized access. These operate in a manner common in the art of website software design. Three buttons 106 allow access to debates and candidate index/information/filter pages on which the user may obtain further information about debates, debate threads, or candidates and set their filter preferences for viewing. The community interaction portion of the site allows users to select debates and candidates organized by their local community—for example, residents of a typical certain municipality will have local, state, and national candidates of interest. This feature of the invention allows users consider topics and candidates from this perspective so they do not need to manually sort their interests out from those in other communities. The viewer's ability to link and filter topics and candidates of interest while still maintaining a smooth, edited feel to the playback stream is an important feature of the invention.

Two tabs 107 allow users to swap views between current and archived debate threads. Debates threads are moved to the archive section a fixed time period after they have closed. Each row of the page encapsulates a debate thread, including a question descriptive of the title 108, last activity 109, and iconic photos of participants 110. A scroll bar 111 allows users to move up and down an extended list of threads in a manner well known in the art. The advertising block 101 is filled in with paid ads, or other banners according to a background process which in the example embodiment is sensitive to user activity generating keywords for a paid revenue advertising link.

FIG. 2 illustrates a sample screen shot showing viewer playback of a selected topic thread, together with other controls and information available to the user. Certain common features with FIG. 1. are repeated and therefore not described. 201 is again a context sensitive advertising bar similar to 101; contents will change periodically in a directed fashion as described above. 202 shows the thread topic. 203 is a frame that displays running debate video content, in addition to any linked in paid advertising segments. 204 is a feature common on web video viewers—the elements include a play/pause button, and moving block indicating where proportionately to the segment the viewer is playing and a dotted block indicating the buffered content that has already been downloaded. These elements are well understood in the art.

205 is a running indicator of where in the linked video stream the user is viewing. Each colored block indicates a change in segment, with length proportionately scaled, the center pointer indicates the location as the blocks scroll through. This element interacts with 206, which shows the sequence of blocks in the current linked video stream. The highlighted block corresponds to the segment currently playing. The arrows on 206 allow the user to scroll back and forth to see what is scheduled in their linked video thread. 207 indicates the person speaking in the present block, by name and by image.

208 is a scroll box of thread topics, indicating the order in which threads will be sequenced. The user can skip to a new thread by clicking here, rather than returning to the debate list page.

209 is a linked comment feature. Comments are indicated in a text tree that is time linked to the video and scrolls as the video progresses. A viewer may view a comment by clicking on it. Clicking on a comment pauses the video thread; text comments are sequenced in box 210, while video comments will pause display in the video area 203, before resuming the scheduled debate thread. The viewer-user may add a new comment using button 212. Comments are treed in a manner well known in the art, and include a “+” and a “−” icon in the tree displayed in 209 to open or close comments and sub comment links. The user may hide or view all comments by using button 211. Button 213 permits the user to mark as favorite the video segment for quick recall.

In typical operation, when the viewer selects a debate to view from the debate chooser, they are taken immediately to a page with a video window that starts playing. The debate is introduced with an overview of the current situation of the debate and then the debate between the candidates commences. For example: “Welcome to the presidential debate. The debate started on Sep. 1, 2007 and we are discussing XYZ. We now join the debate underway, you can rewind to the beginning using the controls below.” and the debate starts showing the last round of discussion. In certain embodiments, a summary clip of the early parts of the debate will precede this.

If the debate has more than one thread, by default they all play sequentially. However, the user may click on video segments to move backward and forward, they may also click on debate threads and change filter setting to move to different topics or view different candidates.

Each debater is then given up to a fixed length of time to talk. After that allotment, the next debater comes on. The fixed length is established in advance and the segments are recorded and edit to fit, as described in a further aspect of the invention below. The responses in this example embodiment are appended in the order the video is received by the web site; however, other methods of concatenation are anticipated and certain of these are discussed above. In this embodiment, the whole sequence of debater's rolls like a continuous film, there is no break and no need for further user intervention. A debate runs like a summary television program, even though the debate may have occurred over the course of several months with candidates contributing video elements asynchronously with each other and the viewers. This is an important feature of the subject invention.

In the example embodiment, beneath the video window, there will be a rolling timeline that shows which debaters are on in what sequence. The viewer can grab this timeline pointer with a mouse pointer to move backward and forward, or may press the forward or back arrows to skip through debaters and segments.

In the example embodiment, there are two views of this timeline: a threaded view showing each thread as a separate timeline and a pure timeline view showing one timeline of all the responses linear. The title or description next to the video indicates which thread is currently playing.

There are two ways to present the threads to the user in this embodiment:
1. the user views the concatenation of the threads according to automatic or selected filter parameters.
2. the user can view each thread individually, this is more like a forum

The user will be able to configure their presentation dynamically, and this configuration will be stored by means of server side data or web cookies so that it can be recalled at their next visit.

Due to the near-real time nature of the debate, viewers may be watching a debate as new video is simultaneously up-loaded. When the viewer reaches the end of available video, the screen will pause and wait for more video to become available. A popup will alert the user that more video is available to watch. The system will track if new input is posted to threads that the viewer has already seen and dynamically add this new video to the end of their scheduled debate view sequence with a transition introduction.

In the example embodiment, viewers will be able to register on the site (but not be required to). A registered user will have access to extended features, including being able to leave commentary on the debate and add new user debate threads. They will also be able to be notified daily of a watch list of debates as new content is posted—either by email or text messaging at their selection. Debates will also be able to be followed with an RSS feed as podcasts.

Viewer users are also be able to rate video segments, and candidates' performance in the debate. In the example embodiment this is accomplished in the example embodiment by poling users after each round of discussion (not illustrated); however, other embodiments may accomplish this by adding a “rate-performance” button to the view window.

Other elements of the example embodiment interfaces identifying website information, paid advertisement (in this case shown at top of screen), and general control buttons including options to “signup” to register new users, “login” for previously registered users, etc. as described above.

When a viewer comes back to the example site, they are, by default, returned to the viewing point from which they left. This is can be accomplished with a “cookie” (as understood in the art to mean a small data file left on the users computer and accessible via their browser) if they are not a registered user or linked to their user data if they are a registered user. The latter allows the viewer to go to a different computer and resume viewing where they left off. Unregistered users can resume only on the computer they last used.

Comments on the debates are not only a very powerful means of ordinary people to communicate their feelings and ideas about the debate to one another, it also a in subject embodiment, a way to involve the viewers in the debates. The viewers are able to pose questions back to the candidates and can potentially prompt the start of a new thread.

In the example embodiment, a viewer poses a question (in text, or video) and other viewers vote on the quality and relevance of the question. Questions with the most votes are high candidates to be threads. The candidates or moderator will be able to simply start a thread using one of these posed questions.

Registered users are able to leave text comments on the debate attached to the timeline of the debate. What this means is that if a user leaves a comment 19m32s into the debate, this comment will appear when other users watch the debate and cross 19m32s into their view of the debate. People are able to reply to comments of comments in a tree-like method easily displayed in a collapsible indented outline format. These comments are subject to moderator review and may be removed where they are inappropriate.

Since many comments may be attached, in the example embodiment when the user opens the tree by clicking on the + icon, the debate video thread stream will pause. Comments with larger chains of replies are indicated in larger font sizes with the number of follow up replies in parenthesis. Comments, as useful as they are, can be overwhelming. They are easily hidden and treated as optional bonus material. Such multi-tiered, linked user interaction is not available in traditional media.

In the example embodiment, viewers can also vote during the debate by using the favorite button. Each thread will have its own current “winner”. The sum total of winning threads is the overall winner. The current winner can be viewed like a stock market graph over time. For example, viewers can track someone's popularity over time with respect to the other candidates much like you could track a set of stocks in the stock market. This graph in certain embodiments has advanced timeline features that link to news items and back into the debate so that users can judge what caused a change in popularity. Other methods of voting are contemplated including a star rating system, and a poll at the end of a debate round; these are not illustrated in the example embodiment but would not depart from the spirit of the invention.

Registered viewers in this example embodiment have the ability to customize their debate views. For example, in a debate with many debaters, a viewer may choose only to see two or three of the debaters. In such a situation, the viewer will be able to see how many other viewers have also turned off a particular debater. This allows feedback to other viewers to let them know which debaters are more popular and worth listening to. This feature is useful in debates with many participants, some of which are not really serious candidates. In the example embodiment, this is accomplished on the index/filer pages (not shown) by checking boxes next to the topics or candidates of interest. As discussed above, the example embodiment includes filter pages organized by debate topic, by candidate, or by community.

In an alternate embodiment, a registered user can create his or her own edited version of the debate. The “power viewer” may create a sequence of extracts of a debate that they think is the most worthwhile and essential parts of the debate (like a re-mix). This debate remix is available to other viewers. Viewers can vote on remixes and more popular ones will be the ones that are viewed. This popular input is available to moderators for use in summarizing debate threads and, in certain instances, is available to media outlets for republication.

Another alternative embodiment will allow “thought balloons” to be added the debates by viewers, or the ability to have a second running commentary audio track. This extra commentary must be selected; it is not on by default otherwise a viewer could be immediately inundated by unwanted comments. These are alternative implementations of the comment viewer feature in the example embodiment.

Debates may be transcribed into text for people who prefer to read rather than watch them, and to provide service to hearing-disabled users. This also will allow segments to be searched and a user can then watch the debate from that point in the search. The search result screen will allow the user to click on the result and play the excerpt of the result in the video window. The example embodiment achieves the translation by applying speech-to-text translation that is subsequently hand corrected by trained transcriptionests.

We now describe the debater's view of the subject system where it differs from the viewer-users view. As mentioned above the first-tier debaters are limited in participation to registered candidates. The embodiment allows “public” debates as well, with these second-tier debates open to all users. Clearly the debater can view the ongoing debates using similar controls as already described.

In the example embodiment, once a registered debater receives their login to the web site, they can log in to the web site and see their debate and the threads that they are in which they are currently permitted to become involved. They have the ability to post video replies to their debates when it is their turn. This restriction exists so that a debater may not hog the debate by posting responses continuously. Other embodiments of restricting turn sequences are discussed above.

Video is posted almost like video telephony using a video recording user interface that is similar to those well-known in the art and so not illustrated. The debater posting a segment to the example site need only use a simple web-cam, though they can invest in whatever type of camera they desire that is compatible with their operating system. In certain embodiments server side programs can instruct client side applications such as Flash to access a video camera, so no additional software is necessary. In the preferred embodiment, we provide a client side application to collect, edit, and transmit video locally. This off-loads work to the client machine, and provides a much more reliable transfer of high quality video without risk of loosing packets. A client side application can also provide software to talk to more expensive video cameras. The video capture client is further discussed below. This same tool is used by second-tier viewer-users to post comments on first-tier debates or responses on public debate threads.

The debate interface guides the debater through the process of posting the video response. It allows them to post and review their post to make sure no major glitch occurred in transmission. It also allows them to review the previous posts to the debate so that they can properly respond; the latter is accomplished using tools similar to those already illustrated in FIG. 2. However, rather than viewing a sequenced video thread, the authorized first-tier debater sees only the thread of interest up to the point at which they are asked to respond. The comment controls 209-212 are replaced with a button to access the video posting tool.

Two types of available video sequencing are permitted in the present embodiment, at the discretion of the moderator:
(a) In a first mode, video posted to the debate isn't available for viewing until all the candidates have posted their response (or a certain time has elapsed);
(b) In a second mode, video posted to the debate appears immediately. The later is preferred in the example embodiment.

Either the round-robin order is conserved through the debate (as in who ever goes first is always first, who ever second always second and so on), or the responses are viewed first-posted-first-viewed. Again in the example embodiments, the system moderator fixes this choice. The moderator also fixes the length of time for each segment of video, and the amount of calendar-clock time permitted to post a video before the system assumes non-participation; the debaters are bound by these parameters.

The other controls on the debater's control panel in the example embodiment include:
1. Ability to vote amongst the other debaters to adjourn the thread
2. Ability to pose a question to one, several or all the other debaters to which each must respond.
3. Ability to respond to a question.
   These features work similarly to the linked comment elements described earlier, and are implemented in straight forward user interface elements well known in the art and are not specifically illustrated.

The direct question option in certain embodiments will show a split view showing the person who asked the question (freeze framed) and their question. Likewise, when responding to a question, the person who had to respond sees the question being asked and the frozen image in the corner while they respond; they click a button in the split screen indicating they have finished responding which removes the frozen image. The respondent can then continue talking until their time is exhausted.

However, in the example embodiment the direct question mode is implemented by allowing debaters (first-tier) to initiate new threads which the others may choose to participate in. Responses from those that are asked are added. The question may be directed only to one other candidate, however in the example embodiment all candidates have the opportunity to respond for the sake of fairness.

The direct question mode of operation permits a new level of controlled interaction between users that is moderated in an evenhanded way. For example, in a debater's allotted time, he or she could click the box to respond to a question previously posed by one debater and click another box informing that they are posing a question back. This sort of feedback from the debaters to the system is used to determine what sort of icon to show for a debater in the viewer view as well: for example whether to show them with their hands over their mouth if they are refuse to answer the question posed. This direct question mode is an advancement over what is possible in traditional media, however it is not a requirement of invention and need not be present in all subject embodiments.

We now describe the Moderator/Director's view of the system. The example embodiment is designed so that each debate may have a moderator and/or director. The “moderator” is an actor who will appear at the beginning of the debate to give an initial briefing or from time to time as necessary. The “director” is a technical person behind the scenes who can control the debate as needed. In certain circumstances they may be one and the same. In certain circumstances the option will not be used, leaving the debates to be automatically moderated.

The director will have some extra privileges to control the debate, for example in choosing which candidate gets to speak when and to add their own video at the beginning, end, and within the debate as necessary. He or she will also control certain options and features as described in other section s of this specification.

The director will be able to start a thread with a question posed in another thread. In this case, an announcement will be inserted by the moderator into the thread. For example, “Please join us in the XYZ topic to discuss this new question”.

The director may also have privileges to create debates and invite debaters. The director is responsible to make sure the debates are not obscene or otherwise nasty. He or she is assisted in the example embodiment by automated detection software. Since the segments are posted near-live but not completely live, the system easily accommodates this without noticeable delay. Public viewer debate postings may be subject to slightly longer delays to ensure compliance with subject and decency rules.

The director can also correct minor problems with candidate inputs, by informing the system, for example, who is asking whom a question in case the debaters make a benign mistake.

These director and moderator features of the subject invention allow elements of user control that correspond more to the traditional debate formats. They are not may not occur in all embodiments but rather are a matter of enabling a broad set of options in potential application. Typically at least one director will participate in each first-tier debate, in order to organize the participants and set initial questions. Often public debates will need less intervention beyond peer pressure.

In addition to the participants, the example embodiment includes an administrator's view. The administration panel is provides a means for underlying operation of the site to be administered. From this view of the site, an administrator can create, modify, and delete a debate. The administrator can also manually create debate accounts for debaters, moderators, and viewers. The administrator will also be able to set and adjust operational parameters such as system backup configuration, data transfers and retry limits, load-balancing options for distribution, and so forth. During a debate, under normal circumstances, no such operator intervention should be necessary. These elements are typical of website maintenance and setup and are well known in the art.

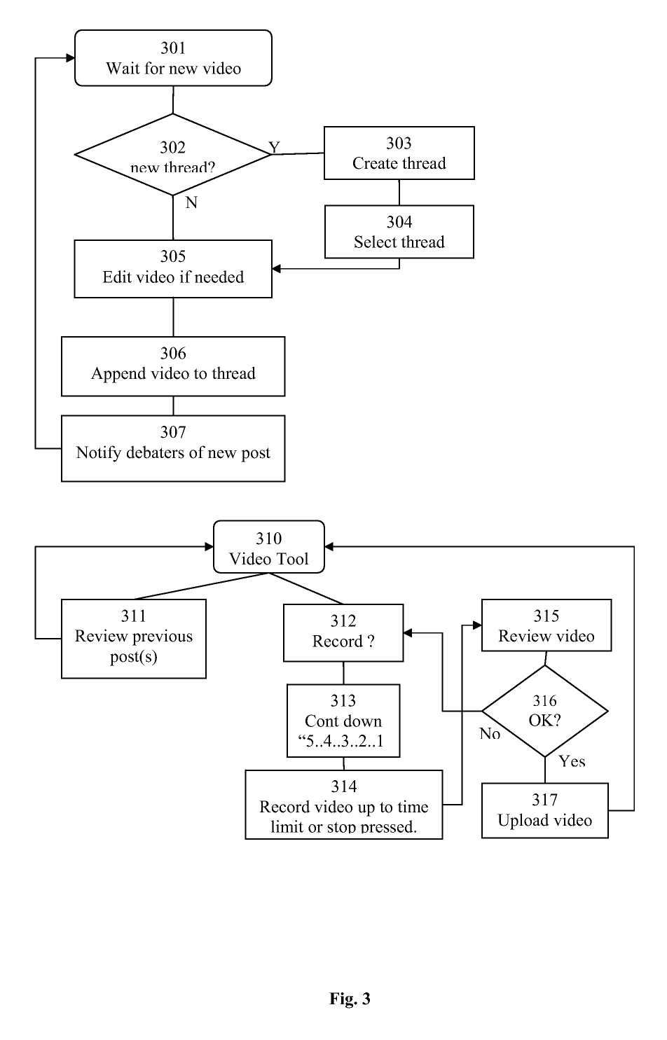

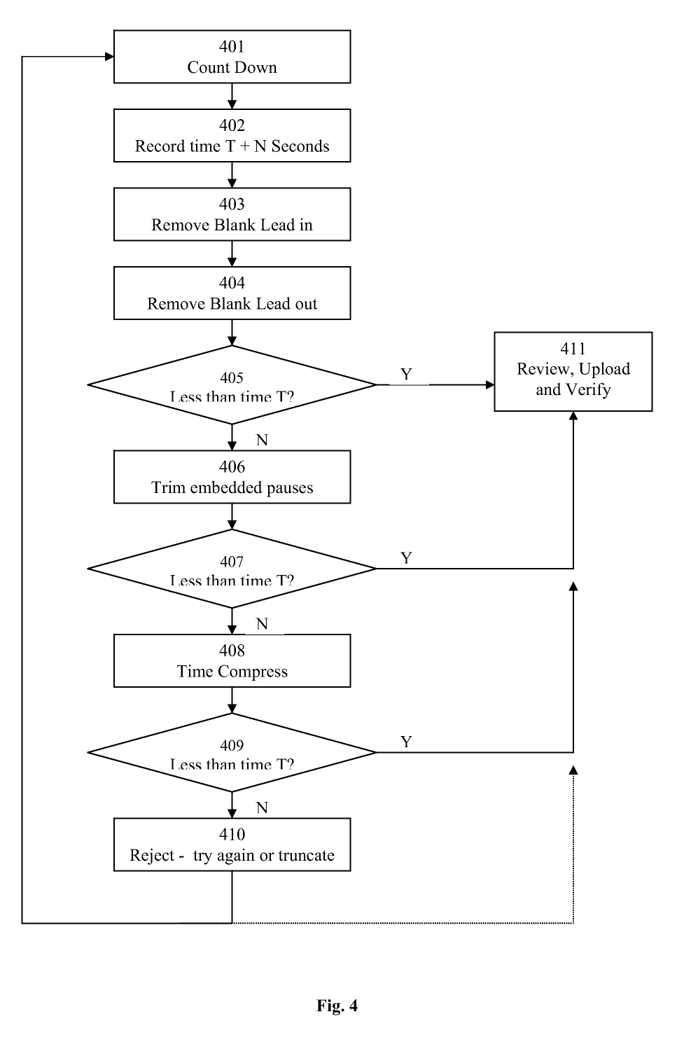

We now describe Video Upload operation as implemented in the example embodiment. FIG. 3 illustrates a pair of flow diagram showing the basic logic of recoding, reviewing, and adding videos to threads in on embodiment of the system. The upper diagram shows the web server process or waiting for new uploads, and classifying and concatenating them as they come in. Once initiated, the process 301 waits for a new video from the video tool. We determine 302 whether it is a new thread, noting that only those users with permission will be able to upload a new thread. If it is new then, 303, we create the thread in the data base if it does not already exist, and, 304, select it as current. Otherwise we will append to the current selected thread. The process in 305 edits the incoming video if needed; see FIG. 4 for further details. In process 306 we upload the new video segment and append it to the selected thread, adding smooth transitions and embedding it in the linked thread video stream for user viewing. In process 307 the first-tier debaters are notified of the new response by their peer. We then return to the wait state 301.

The lower diagram shows operation of a video tool on the client side that allows the debater to review his or her previous posts, or to record a new video. The process begins in 310. The debater may review previous posts 311 using a display tool as described previously. The user may also record 312. In the event the new video is recorded, we check camera and audio status, and provide a count down 313. This countdown indicator counts in the start point, and then indicates time elapsed so that the debater can time their speaking to the set segment length. Recoding proceeds until 314 the set time limit is reached or stop is pressed. The process then automatically 315 reviews the video segment by playing it back to the debater giving the opportunity to re-record 316. Once the debater approves the video we up-load it to the website 317.

Certain embodiments will include features that make the process much more user friendly. Recording video perfectly is difficult and it is important to provide sufficient automatic editing features so that users need not repeat from scratch when minor corrections will suffice. One goal of the example embodiment is to maintain a live feel to the video segments rather than allowing extensive pre-production to give one candidate and advantage over another.

In the preferred embodiment, the candidate is given three buttons for “record”, and “stop”. Video recording by the candidate is initiated by pushing record. It begins with a count in, followed by onset of recording. Recording proceeds for the allotted time T plus an overrun time of N seconds. Typically T is between 30 seconds and 5 minutes, and N is around 15 seconds. The candidate has three virtual lights, green, yellow, and red, in their window. The green light is illuminated as recording starts. As time T approaches, the candidate is warned, first with the yellow light at 15 seconds, a flashing yellow at 5 seconds and a red light at 0 seconds. However, to allow smooth overruns recording continues until N seconds after this time. In certain embodiments recording commence at the count-in start before the light turns green, in order to capture “pre-roll” and avoid rerecording due to a flight mistiming of the start point.

The additional recording time is provided to allow smooth transitions by the candidates and facilitate easy corrections to the resulting video segment without requiring the candidate to repeat their entire speech unnecessarily. Hitting stop at any point will terminate the recording early. Once they have completed the their segment, if it can be successfully fit in the specified time they are present the option to “Review”, “Post Video” or to “Cancel”. “Cancel” will abandon the recording. “Review” will play back the recording and present the same options again.

The capacity to repeat, and automatically trim and adjust debater video is a unique element of the invention made possible by moving to the asynchronous online setting. It gives all participants an equal opportunity to polish their responses and comply with posted rules rather than requiring them to sacrifice clarity and rush due to minor timing errors. For example, if a speaker needs to finish a sentence the system will not cut the recording off mid word, but rather try and accommodate reasonable attempts to comply with timing.

The automatic editing process used in the example embodiment is illustrated in FIG. 4; its application is novel in the context of live debates and enforcing rules of order in a evenhanded, automated fashion. As disused, the count down is presented in process 401. The recording commences and continues 402 for a period of time T plus an additional overrun time N. The system then attempts to adjust the recorded segment to fit in the allotted time T. First in process 403 it removes leading quiet space before the speaker starts, then process 404 trailing quiet space after the speaker finishes. If this reduces the time sufficiently to comply with the limit T (405), it presents the video for review in 411, then uploads and verifies at the user option. If the video is still too long, other methods are employed: first in process 406 embedded speach pauses are detected and trimmed, again testing for success. Next in process 408 well-known signal processing technology can be employed to time-compress the video (while avoiding audio pitch shifting)—reasonable limits are set at a few % time compression to avoid noticeable artifact in the speaker's video playback. At each stage 407 and 409 we move to 411 if we have succeeded in complying with the time limit. If after all attempts, the video segment remains too long, the debater is asked to try again. In some embodiments (shown with dotted lines) the debater is given the option to post the video truncated rather than re-recording. In other embodiments, hand deletions of video portions is permitted.

Video download operation is used allow users to view linked video threads. FIG. 5 illustrates a pair of flow diagrams showing the basic operational logic of different modes of playback available on the website. The top diagram (FIG. 5A) shows the user options for navigating the site in a basic embodiment. These have been discussed above in detail with improvements and variations on the basic design illustrated. In this example embodiment the user enters at process block 501. If they proceed to the debate list 502 without signing in, the system debate 503 and displays a list of threads 504 within that debate. The system then begins streaming video of the thread in the linked chronological order as assembled by the processes described above. As indicated in 505 it defaults to the first thread, unless the user has a cookie on their machine indicating another start point. In 506 we determine if there are more threads, if so we continue to the next thread; if not, we return to the lists of debates.

If the user chooses to sign in at anypoint 510, we display 511 a personalized lists of debates. These personalized lists are determined using viewer selected filter options by debate, by thread, by candidate, or by community as described previously and not illustrated in this core diagram. We open the debate of interest 512, again displaying a personalized lists of threads 514 as set by user filter information described above. We assemble and stream the content of the thread 515, starting at the users preference or last end point. Threads are then streamed sequentially if there are more 516 to be shown. In each case candidate interest filters are applied to eliminate candidates of no interest from the video streams. At any time the user may add a comment 513(a) (b) to either the thread video stream or to the debate itself.

FIG. 5B illustrates podcast operation, which figure was previously described. The podcasts effectively comprise a collection of streamed video assembled in the same fashion described above but downloaded for independent playback rather than viewed on the website directly.

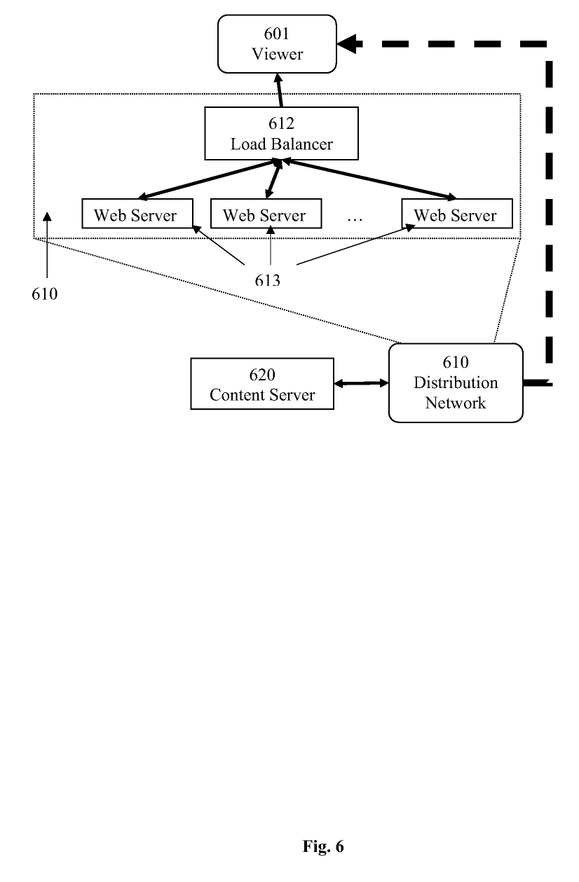

FIG. 6 is a system block diagram illustrating the use of web distribution to serve large numbers of users with on-demand content. The content-server 620 provides primary data including videos, user accounts, text threads, and other information at a central point. The distribution network 610 serves this content to multiple users via a load-balancing arrangement that enables delivery to tens-of thousands to millions of simultaneous uses. The dotted arrow indicates the system level path from the distribution network 610 to the viewer 601. The dotted frame is an expansion of the key elements of the distribution network 610, including redundant parallel webservers 613 and a load balancer 612. These elements are not crucial to the invention, however are included to illustrate to those skilled in the art a mechanism by which the embodiments of our core invention may be fully enabled in a live setting.

In the example embodiment viewers are served via the load balancing system, while debaters may be served in a separate, higher priority tier of distribution. This system can be graduated so that priority is assigned to the level of significance of the user. For example, presidential candidates may receive very high interaction priority, local government candidates such as school board members may receive a lower interaction priority, and general viewers basic as-available level of priority.

In the preferred embodiment an additional separate access method is provided for media, news organizations, and researches. This library interface indexes video and audio clips by topic, date, time, candidate and other subject matter. It also includes still images that have been selected by previous users for download, or by independent moderators as particularly good for re-publication. This library is independent of the ongoing debates, except insofar as drawing material from it.

The example embodiment illustrates the invention in the context of debates for election races; however, the invention is in no way intended to be limited by this application example. Referendum discussions and other ongoing local and national debates are other political applications. The invention can also be used to provide services for private discussions groups, and for corporate and institutional applications. Board meetings and stockholder meetings can benefit. It can also be used for more general web forum discussions, where video is preferred over text as a means of communications. Nor is the system limited to the U.S.A.; the system can also be translated into multiple languages and operate in many countries.

Video has the clear advantage over text only forums in that far more information, emotion, and presence is conveyed by this modality. Moreover, showing a personal presence will allow users to clearly differentiate from the semi-anonymous behavior typical of text-based interaction enabling their presentations to carry correspondingly more weight in the discussion. The system, as discussed can be implemented with any modality of information and includes elements of linked text and other discussions in addition to the video and/or audio streaming. “Audio-visual segments” may include just images, just audio, or full video with both components, as well as linked texts or html aspects. We do not claim threaded text discussion in the absence of other novel aspects of the invention, as this component is known in the art.

Upon reviewing the novel combinations of elements disclosed in the specification and figures and the teachings herein, it will be clear to those skilled in the art that there are many ways in which the subject invitation can be implemented and applied. The above description relates to the preferred modes and example embodiments of our invention.

The descriptions above are intended to illustrate possible implementations of the present invention and are not restrictive. We contemplate variations and additional features and functions within the skill of the art, including advances in operational technology. Various modifications other than those discussed above may be resorted to without departing from the spirit or scope of the invention. Variations, modifications and alternatives will become apparent to the skilled artisan upon review of this disclosure. For example, equivalent elements may be substituted for those specifically shown and described. Certain features may be used independently of other features, various methods independently described may be combined, and in certain cases, particular locations of elements may be reversed or interposed, all without departing from the spirit or scope of the invention. The scope of the invention should therefore be determined with reference to the description above and the appended claims, along with their full range of equivalence.

What is claimed is:

1. A system for conducting on-line discussion comprising:
a means of contributing audio-visual segments by a at least one class of user;
a means for asynchronously collecting contributed audio-visual segments from said users without regard to any fixed playback order;
a means of grouping audio-visual segments into related sets;
a means of concatenating grouped audio-visual segments into a smooth audio-visual stream for playback;
a means for playing back the concatenated audio-visual segment stream on demand by at last one class of user.

2. The system of claim 1 which system permits at least two classes of user, a first class that is privileged to contribute audio-visual segments to one or more specific grouped sets and a second class that can view the concatenated visual segments but may not contribute to said concatenated segment stream.

4. The system of claim 1 with the addition of a means of producing an audio-video segment of standardized format and duration from a non-standardized recording by users.

5. The system of claim 1 with the addition of means for inserting content based advertising.

6. The system of claim 1 where said system is used for conducting political debates, wherein a first class of user comprises debate participants and a second class of user comprises the general public.

7. The system of claim 1 wherein the system is used for discussion of topics selected by users of at least one class.

8. The system of claim 1 which includes at least one user class that must approve topical threads but may not participate in the debate.

9. The system of claim 1 where the availability of a new topic thread audio-visual segment stream is delayed until majority of at least one class of users have posted audio-visual segments.

10. An automated method for collecting audio-visual segments in a standardized format and duration for use in comprising:
a means for establishing the target duration and total recording duration;
a means for recording the audio-visual segment for the total recording duration;
a means for indicating to the user the start time of the recording period;
a means for indicating to the user the end time of the recording period;
a means for adjusting the length of the recorded segment subsequent to recording to comply with the target duration limits without user intervention.

11. The method of claim 10 where the means for adjusting said segment length includes trimming of leading and trailing quiet space from the audio-visual segment.

12. The method of claim 10 where the means for said adjusting segment length includes removal of portions of quiet space from within the audio-visual segment.

13. The method of claim 10 where the means for adjusting said segment length includes digital time-compression of the audio-visual segment.

14. The method of claim 10 wherein the target duration is a maximum limit and audio-visual segment recordings of shorter duration are not increased in length

15. The method of claim 10 further comprising means for organizing the standard audio-visual segments into a smooth stream of such segments for playback.

16. A system for conducting on-line discussion comprising:
a means of contributing audio-visual segments by a at least two classes of user;
a means for asynchronously collecting contributed audio-visual segments from said class of users without regard to any fixed playback order;
a means of grouping audio-visual segments into related sets;
a means of concatenating grouped audio-visual segments into a smooth primary audio-visual stream for playback;
a means for playing back the concatenated audio-visual segment stream on demand by at least one class of user;
a means for said second class of user to contribute segments to at least one additional playback stream that is independent of the primary audio-visual stream.

17. The system of claim 16 wherein the additional playback stream is textual.

18. The system of claim 16 wherein the additional playback stream is audio-visual.

19. The system of claim 16 wherein the segments of said additional playback stream may be linked into the primary audio-visual stream.

20. The system of claim 16 with the addition of means for said second class of users to select a subset combination of audio-visual segments and means of producing a smooth user-specific audio-visual playback stream based on said means of selection.
